(19) United States
(12) Patent Application Publication
(10) Pub. No.: US 2017/0205325 A1
(43) Pub. Date: Jul. 20, 2017

(54) Device For Measuring Viscosity In An Inert Atmosphere

(71) Applicant: S.P.C.M. SA, Andrezieux Boutheon (FR)

(72) Inventors: Ludwig Gil, Andrezieux Boutheon (FR); Cedrick Favero, Saint Romain Le Puy (FR); Jean-Sebastien Fruchart, Andrezieux Boutheon (FR)

(21) Appl. No.: 15/403,811

(22) Filed: Jan. 11, 2017

(30) Foreign Application Priority Data
Jan. 18, 2016 (FR) 1650383

(51) Int. Cl. G01N 11/14

(52) U.S. Cl. CPC G01N 11/14

(57) ABSTRACT

Device for measuring the viscosity of a solution whose viscosity is unstable under aerobic conditions, the device being intended to be connected to a source containing the solution and including: a viscometer including a viscometer head wherefrom a module emerges; a container into which the module is immersed, mechanism for placing the interior of the container in contact with an inert gas, a purging mechanism, characterized in that the container has inlet mechanism for the solution intended to be connected to the source.

### FIELD OF THE INVENTION

The object of the invention is a device for measuring, in an inert atmosphere, the viscosity of solutions, the viscosity of which is unstable during viscosity measurements in an aerobic environment.

### BACKGROUND OF THE INVENTION

Several oil production methods can be implemented depending upon the situation. Primarily:
primary production relating to the spontaneous production of oil by the internal pressure of the reservoir;
secondary production wherein the internal reservoir pressure is maintained by water injection; and
tertiary production constituting various enhanced oil recovery methods.

The appropriate method is selected based upon the necessary investments (capex) and operational costs (opex) that are themselves related to the type of oil, type of reservoir and viscosity of the oil.

The many enhanced oil recovery methods implemented in an oil well each have their advantages. Among these methods are included:
the re-injection of the gas produced;
the injection of carbon dioxide the purpose of which is also to avoid the greenhouse effect;
the injection of various solvents;
steam heating for heavy oils;
the injection of bases for acid oils;
the injection of surfactants;
in-situ combustion by injecting oxygen;
biological methods with the formation of organic surfactants;
electric field diffusion methods.

One of the simplest and most effective methods is to inject a viscous aqueous solution.

The solution is rendered viscous by the dissolution of water-soluble polymers, and especially of polyacrylamide, xanthan gum, and more anecdotally, of guar gum or ethers of cellulose.

Polyacrylamides are the preferred additives in that they present better resistance to biodegradation than the xanthan gums that in particular require the use of high doses of toxic bactericides, especially formaldehyde, in order to be protected from biodegradation.

In general, the polymer injection enhanced oil production method mainly consists of dissolving the polyacrylamide, delivered in the form of powder or emulsion, at a high concentration such as 5 to 20 g/L, in water or deoxygenated brine (in order to avoid the degradation thereof); and to inject this stock solution into the water or brine injection tubing and to inject the resulting mixture into the well under consideration.

The objective consists in maintaining a constant viscosity during the injection of the water-soluble polymer solution, in order to obtain a satisfying sweep of the reservoir.

One of the problems encountered when using these aqueous solution of water-soluble polymers is that the polymers can be subjected to chemical damage. These chemical degradations are due firstly to the formation of free radicals that react with the main polymer chain and cause a drop in the molar mass. This results in a drop in viscosity of the solution linked to a reduction in the hydrodynamic volume. The free radicals can come from different sources: they can be generated by the splitting of weak bonds within the chain of polymers under the effect of heat/friction or the residues of initiators or by-product impurities. Red/ox systems are also generators of free radicals. The latter results for example from contact between the pollutants present in the production water such as H₂S or ferrous iron or any other pollutant representing a potential reducer and an oxidizer such as oxygen for example.

The presence of oxygen is the most harmful factor regarding the degradation of the polymer. The polymer degradation reaction due to oxygen is, in addition, amplified by the presence of metal such as iron or by the presence of hydrogen sulfide. Such degradation can therefore occur within the pipe within which the water-soluble polymer solution circulates within the well, but also during sampling for various purposes, especially if the latter is performed in open air where the amount of oxygen is far greater than that present within the pipes or the well.

Moreover, in addition to chemical degradation, within the reservoir, the polymer can be submitted to biological (bacteria.), and mechanical (i.e., due to injection into the well) degradations, but also to disturbances due to adsorption into the rock of the reservoir and the effect of dilution.

Therefore, in order to optimize the injection of the viscosified solution, it is important to precisely determine the degree of impact on the polymer of each of these stages. However, when taking samples of the aqueous polymer solution, wanted or unwanted contact with oxygen often occurs which has the consequence of strongly degrading the viscosity of the polymer, which then becomes an unusable parameter for analysis.

In this context, it is important at different stages of the process, for example upstream or downstream of the introduction thereof within the underground formation, such as the injection and oil production wells, to be able to control the quality of the injected aqueous solution of water-soluble polymer, particularly in order to estimate the performance of the injection within the well. For this, it is necessary to arrange for sampling techniques that maintain the integrity and the characteristics of the polymer, which is not without difficulty.

The document “effective propagation of HPAM solutions through the tambaredjo reservoir during a polymer flood” by Manichand and col published in SPE Production & Operations, November 2013, p 358-368, describes a method for measuring viscosity using a viscometer wherein the sample carrier is fed continuously by a polymer solution in a completely aerobic environment. Although this system allows satisfactory viscosity measurements to be obtained, these can still be improved.

The document FR 2977630 describes a method for the sampling of an aqueous solution of water-soluble polymer circulating within the main circuit of an enhanced oil recovery installation. In practice a stabilizing solution is added to the aqueous solution of water-soluble polymer in a discontinuous manner, before or after the withdrawal thereof from the main circuit, in order to obtain a sample consisting of a mixture of the water-soluble polymer and the stabilizing solution. Because of the presence of stabilizers, the water-soluble polymer is protected against attacks that it might suffer in the absence of the stabilizing solution, in an atmosphere comprising at least 10% by volume of oxygen. In practice, the solution is stored within a hermetic sampling tank. The tank is then transported to a glove box whereupon the viscosity measurement is performed in an inert atmosphere. Reproducible values are thus obtained. Glove boxes are however large, expensive and are not without logistical and maintenance problems particularly on oil platforms. In addition, it is necessary to take the sample and to then transport said sample to the glove box. Also, the risk of the polymer solution coming into contact with oxygen when the sample is being taken remains a major drawback.

Although this method has led to significant improvements during further analyses of the viscosity of said solution, the quality and reliability level of viscosity measurements can be improved.

An alternative solution is to measure the viscosity of the aqueous polymer solution within a glove box.

The problem that the invention therefore proposes to solve is to develop a viscosity measurement device that is as reliable as a glove box and that guarantees the absence of oxygen polymer solution contamination when the sample is being taken.

### SUMMARY OF THE INVENTION

In order to have reliable viscosity measurements of water-soluble aqueous polymer solutions with a simple, easily transportable and inexpensive device, the Applicant has developed a device for measuring viscosity, in an inert atmosphere, of solutions, wherein the viscosity is unstable during viscosity measurements under aerobic conditions.

The device for the measurement of viscosity in an inert atmosphere includes a viscometer and sample carrier, characterized in that only the sample carrier is partially or totally inert.

Another aspect of the invention is a method for measuring, in an inert atmosphere, the viscosity of a solution that is sensitive to degradation within an aerobic environment using the previously mentioned device.

Finally the invention also concerns the use of the device previously described in order to determine the viscosity of an aqueous solution of water-soluble polymer, said solution originating from the main circuit of an oil recovery installation.

Specifically, the object of the invention is a device for measuring the viscosity of a solution, the viscosity of which is unstable in an aerobic environment. This device is intended to be connected to a source that contains the solution, and includes:
a viscometer comprising a viscometer head wherefrom a module emerges;
a container into which the module is immersed,
a purging means.

The device is characterized in that it further comprises means for placing the interior of the container in contact with an inert gas, and in that the container has inlet means for the solution intended to be connected to the source.

In the following description, the device of the invention is more particularly described in relation to measuring the viscosity of a polymer solution implemented within an oil recovery installation. Nevertheless, and as already said, the device of the invention can be used for any solution wherein the viscosity is unstable under aerobic conditions.

In other words, the invention consists in connecting to the container holding the polymer solution to be analyzed either on the main circuit wherefrom said solution is taken or a sampling tank containing the solution to be analyzed of the type described in the document FR 2977630. The polymer solution is thus placed directly in contact with an inert atmosphere near the installation. Thus, the solution to be analyzed is never in contact with ambient oxygen and the viscosity measurement conditions are found to be optimized.

In the rest of the description and the claims, the expression “viscometer head” refers to the assembly containing means for rotating the module and at least one display device (for the value of the viscosities, digital or dial with a needle) as well a control mechanism for the device (start, settings).

Similarly, the expression “oil recovery”, refers to an enhanced oil recovery process or a hydraulic fracturing process.

The expression “primary circuit” refers to the assembly that includes piping, but that can also include storage or maturing vats within which the viscosified solution flows. The sampling can be performed on the piping or storage or maturing tanks where the circulation of the polymer is much slower.

According to a first characteristic, the inlet means for the solution is in the form of a tube emerging into one of the walls of the container, preferably, at the bottom of the container.

In a first embodiment, only the inside of the container is in contact with an inert gas. In this case:
the container is closed with a lid and the module passes through the center of said lid,
the means of placing the inside of the container in contact with an inert gas is in the form of a tube supplied with inert gas connected directly to one of the walls of the container above the level of the solution,
the purging means is arranged on the side wall of the container.

Advantageously, the junction between the module and the center of the lid is tight, in such a way as to not allow the inert gas to escape. This is the case when proceeding with a static inerting.

In a second embodiment, the container is open and, in addition to the inside of the container, the volume separating the viscometer head from the container is rendered inert.

In this case, the means of placing the inside of the container in contact with an inert gas is in the form of a sealed closure means separating the viscometer head from the opening of the container in combination with a means of supplying inert gas to the volume separating the viscometer head at the solution level.

Advantageously, the sealed closure means is in the form of an o-ring or a sleeve.

Preferably, the purging means is arranged on the side wall of the container.

In a third embodiment the container is open and the assembly formed by the container and the module is included within an inerting chamber, with the exception of the viscometer head. The inerting chamber is thus supplied with inert gas and the tube supplying the solution passes through the wall thereof.

Specifically, in this case, the means of placing the inside of the container in contact with an inert gas is in the form of a sealed enclosure within which are located the single constituent module of the viscometer and the container, and into which open:
a pipe supplied with inert gas,
the inlet means for the solution intended to be connected to the source,
the purging means.

Advantageously, at the base of the viscometer head, the enclosure has sealed rigid connection means.

In a specific embodiment, the enclosure has the shape of a parallelepiped, whose length is between 30 and 60 cm, the width is between 30 and 60 cm and the height is between 30 and 50 cm.

To install the viscometer sample carrier and also in order to clean the enclosure, outside those periods of being inert, the enclosure has an access door for the hands of the operator.

In all of the embodiments, the purging means is preferably a safety or calibrated valve, a non-return device or a drain valve.

Whatever the embodiment of the device of the invention, optionally, the means of sealing is used for all openings (the inert gas supply, the purging means, the polymer solution supply, the access door, the viscometer head) during the installation of the supply lines (gas, polymer) or the purging means to the inerting chamber or optionally during the externalization of the viscometer head or closing of the access door.

Preferably, this sealing means is in the form of joints arranged around the edge of each opening.

Whatever the embodiment of the device of the invention, optionally, the container has a means for evacuating the polymeric solution arranged on the wall thereof, below the maximum level of the polymer solution, when present in the container. A siphon or valve can be used as the evacuation means. This evacuation means is designed to avoid diffusion of oxygen into the polymeric solution.

The present invention also consists in a method of analysis, in an inert atmosphere, of the viscosity of a solution whose viscosity is unstable in an aerobic environment. This method is characterized in that it implements the previously described device and includes the following steps:

a) Render at least the inside of the container inert;

b) Inject the solution to be analyzed into the container;

c) Measure the viscosity of the solution to be analyzed

The solution, wherein the viscosity is unstable in an aerobic environment, can be aqueous, organic or a mixture of both.

The measured viscosity is a dynamic viscosity. Preferably, this dynamic viscosity is determined using a Brookfield viscometer.

The temperature of the solution to be analyzed is optionally controlled within the sample carrier by means of a heat transfer fluid of a preset temperature circulating within the double wall of the sample carrier.

The inert gas is selected from nitrogen, carbon dioxide or rare gases such as neon or helium. Preferably the inert gas is nitrogen.

Preferably the oxygen content of the inert atmosphere within which the sample carrier is partially or totally inert can be measured.

Preferably, the oxygen content of the atmosphere is measured with a probe between step a) and b) of the previously described analysis method.

Establishing the inert atmosphere is preferably performed by means of cycles of filling the volume to be rendered inert with inert gas and then purging it or by a continuous sweep of the volume to be rendered inert with inert gas, the excess inert gas leaving from a calibrated valve or a drain valve.

Optionally, the viscosity measurement is performed continuously thanks to the controlled flow of the polymeric solution and the presence of a polymeric solution evacuation means arranged in the wall of the vessel below the maximum level of the polymeric solution when it is present within the container.

Finally, the invention also concerns the use of the previously described device for measuring the viscosity of an aqueous solution of water-soluble polymer, said solution originating from the main circuit of an oil recovery installation.

In a first embodiment, the device of the invention is directly connected to the main circuit of the installation within which the polymer solution circulates, the viscosity of which is to be measured. The main circuit is thus used as a polymer source.

The viscosity measurement will be dynamic and preferably measured using a Brookfield device.

The aqueous solution of water-soluble polymer is preferentially stabilized with a stabilizing solution comprising at least a stabilizing agent chosen from among deoxygenating agents, precipitating agents, radical captors, complexing agents, H₂S absorbing agents and sacrificial agents. Preferably, the stabilizing solution contains at least three stabilizing agents chosen from among deoxygenating agents, precipitating agents, radical captors, complexing agents, H2S absorbing agents and sacrificial agents.

Such stabilizing agents, well known to a person skilled in the art, will conventionally be chosen based upon the conditions encountered during the use of the polymer as it is presented in the table below.

| Polymer usage conditions | | Stabilizer | Role of the stabilizer |
|---|---|---|---|
| Polymer | Action on | Deoxy- | Eliminates the |
| radical | the source | genating | residual oxygen |
| degradation | causing or | agent | |
| limitation | accelerating | Precipitating | Complex and |
| by: | the formation | agent | Precipitates metal |
| | of radicals | | ions in order |
| | | | to reduce their |
| | | H₂S | Captures the H₂S |
| | | absorbing | present |
| | | agent | |
| | Action of capturing | Radical | Forms non degrading |
| | free radicals formed | capture agent | radicals that are more |
| | before they attack | | stable with respect |
| | the polymer | | to the polymeric chain |
| | | Sacrificial | Very quickly reacts |
| | | agent | with the radicals |
| | | | formed to absorb them |
| Thermal | By an action of | Complexing | Complexes the metal |
| polymer | complexing ions | agent | ions with a valence |
| thermal | having the ability | | greater than or equal |
| degradation | to interact with | | to two in a broad |
| limitation | anionic groups | | sense (transition, |
| | within the polymer | | metals, alkalines, |
| | in order to | | alkaline-earth metal) |

In a particular embodiment, the water-soluble polymer solution is stabilized by means of a sampling device that is designed to be connected to the main circuit within which the aqueous solution circulates.

In these circumstances, the device of the invention is connected to the outlet of the discharge pipe of the sampling tank, of a sampling device, the latter itself being connected to the main circuit of the installation, said sampling device comprising:
A first tank, called the sampling tank, for containing the collected sample, comprising:
   An inlet for the aqueous polymer solution to be sampled, and a sampling line connected to said inlet, said sampling line being equipped with a no-shear sampling valve and designed to be connected to the main circuit and
   An outlet and an outlet pipe equipped with an outlet valve and connected to the outlet
A second tank, referred to as the treatment tank for containing a stabilizing solution, having an output for the stabilizing solution, a connecting pipe connected to the outlet for the stabilizing solution and equipped with a treatment valve and allowing, at least in part, for a connection between the treatment tank and the sampling tank.

The sampling tank is hermetically isolated when the sampling valve, the outlet valve and the treatment valve, and possibly other valves which would be present in order to ensure external communication with the sampling tank, are closed.

The stabilized sample thus obtained can be analyzed directly by following the steps from a) to c) of the claimed method.

As an alternative, the device of the invention is connected to the outlet of the sampling tank discharge pipe, previously detached from the sampling device.

The device according to the invention is suitable for the analysis of the viscosity of any kind of water-soluble aqueous polymer solutions in an inert atmosphere, known to have a functional role and/or be conventionally used in an oil recovery process or hydraulic fracturing processes. Sampling can be performed before the entry of the aqueous polymer solution into the oil well, also known as the reservoir, or before the injection thereof into rock. It will thus be possible to determine the quality of the polymer at the sampling point and possibly to provide, before the injection thereof, a suitable treatment using certain stabilizing additives, an adjustment to the dosage or a change to the injection parameters It is also possible to use the device of the invention to measure viscosity at the outlet of an oil or rock reservoir, in order to verify whether the polymer has undergone degradation within underground formations. Sampling and checking using the device of the invention at the inlet and outlet of the oil or rock reservoir may also be included.

In particular, the water-soluble polymer present within the aqueous solution to be sampled may, in particular, be any kind of organic, synthetic or natural polymers that are soluble in water. Notably, the water-soluble polymers described by the applicant within the application for patent FR 0953258 may be present within the injected aqueous solution. This includes, for example, acrylamide based polymers. Most often, the water-soluble polymer used has a molecular weight that is greater than or equal to 1 million g/mol, especially belonging to the range of 1 to 35 million g/mol. Acrylamide based polymers are preferable, and especially those in which the acrylamide, preferably represents at least 10% by moles. In particular, the aqueous solution to be sampled can contain at least a copolymer of acrylamide with either acrylic acid, 2-acrylamido-2-methylpropanesulfonic acid or N-vinyl pyrrolidone. It is possible that the sampled aqueous solution contains several water-soluble polymers.

Due to the selection of monomers and of the various polymerization additives, the polymer within the sampled aqueous solution will have a linear, branched, cross-linked structure or comb (“comb polymer” in English) or star (“star polymer” in English) architecture.

Most often, the aqueous polymer solution will be implemented in brine. Optionally, the aqueous polymer solution can contain an alkaline agent, for example selected alkali metal or ammonium hydroxides, carbonates and bicarbonates, such as sodium carbonate. The aqueous polymer solution can also contain at least one surfactant.

The polymer concentration within the aqueous solution, and especially within the brine is, in general, greater than 50 ppm, and, most often, between 100 to 30,000 ppm.

### BRIEF DESCRIPTION OF THE DRAWINGS

The invention clearly emerges from examples supported by attached figures.

FIG. 1 is a schematic representation of the device of the invention according to a first embodiment.

FIG. 2 is a schematic representation of the device of the invention according to a second embodiment.

FIG. 3 is a schematic representation of the device of the invention according to a third embodiment.

FIG. 4 is a schematic representation of the device of the invention according to a fourth embodiment.

### DETAILED DESCRIPTION OF THE INVENTION

### Example 1: Embodiment of the Device

According to the invention, the device includes:
a viscometer with a viscometer head (1) wherefrom a module (5) emerges;
a container or sample carrier (4) into which the module is immersed (5).

According to an essential characteristic, the container is arranged at the bottom of a hole provided with an orifice (13) in the bottom thereof into which a solution feed pipe (12) opens, the pipe being intended to be connected by the other end thereof to a source of solution the viscosity of which is to be determined.

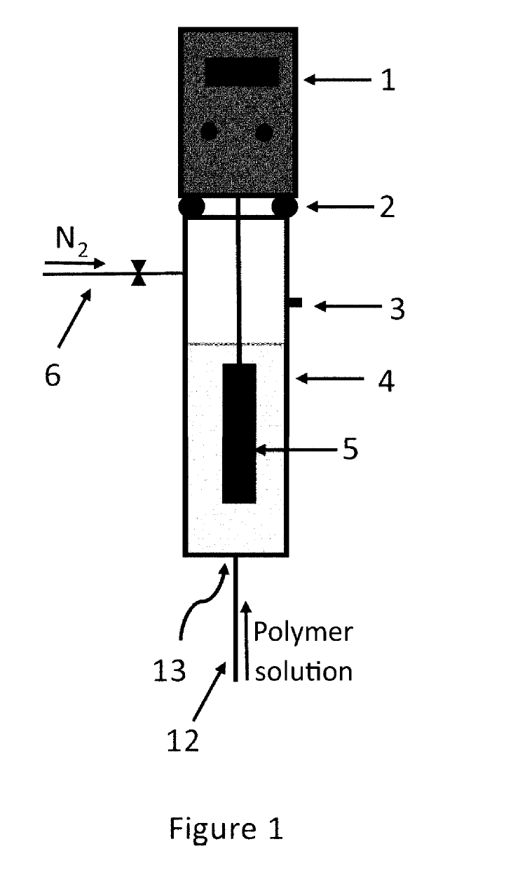

In a first embodiment (FIG. 1), the sample carrier is partially inert. In this case, the device includes a sample carrier (4) wherein the upper part comes into contact with the head of the viscometer (1) by means of a joint (2) while keeping the module (5) of the viscometer immersed in the solution to be analyzed and without coming into contact with the bottom of the sample carrier.

As already mentioned, the head of the viscometer includes at least one display device (for the value of the viscosities, digital or dial with a needle) as well as a control mechanism for the device (start, settings) as well as for a motor for rotating the module.

For this embodiment, such that the internal volume of the sample carrier is sufficiently closed to ensure a gas seal, an o-ring (2) is positioned between the head of the viscometer and the opening of the sample carrier such that the total volume, including the internal volume of the sample carrier and the internal volume of the joint, form a single closed and gas sealed volume.

Thus, the internal volume of the sample carrier surmounted by a joint, can be filled with inert gas (6) thanks to an opening arranged in the side wall of the sample carrier to receive the inert gas inlet. The container can be purged thanks to a purging means (3) arranged on the side wall of the container.

The opening for the nitrogen inlet and the purging means are arranged above the maximum level occupied by the solution to be analyzed within the sample carrier.

Thus, the purging means allows the container to be purged by removing the inert gas without the solution to be analyzed being evacuated from the container.

The purging means is preferably a safety or calibrated valve, a non-return device or a drain valve.

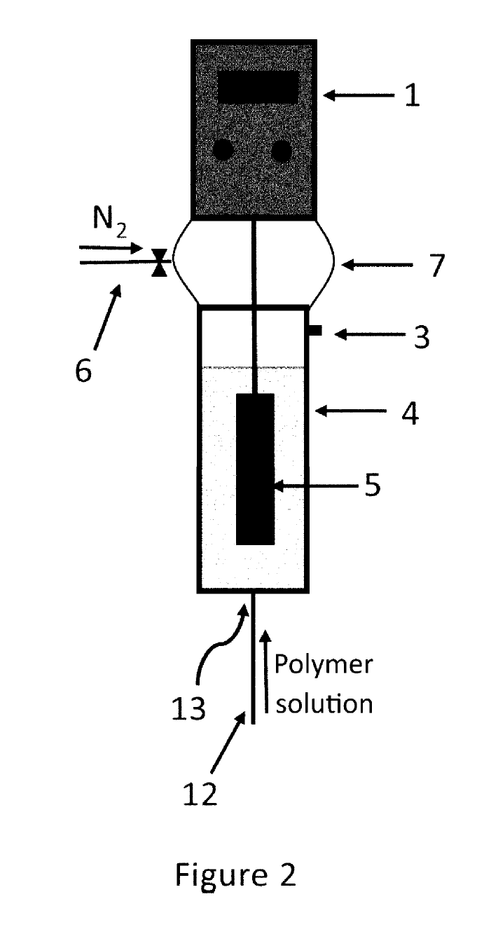

In a second embodiment (FIG. 2), the sample carrier (4) is partially inert and the device includes a flexible or rigid connecting means (7), between the head of the viscometer (1) and the top of the sample carrier.

Thus, the total volume including the internal volume of the sample carrier and the internal volume of the sealing means forms a single closed and gas sealed volume.

Preferably, the connecting means is a cylinder or a sleeve which can be fixed in a gas-tight manner thanks to the elasticity thereof on the base of the viscometer head and on the opening of the sample carrier.

The closed and sealed volume including the internal volume of the sample carrier and the internal volume of the connecting means can be filled with inert gas by means of an opening for receiving the inert gas inlet (6) and can be purged thanks to purging means (3). As shown in FIG. 2, the inert gas supply opening is arranged directly in the sleeve while the purging opening is arranged in the side wall of the container.

The inert gas inlet opening and the purging means are positioned above the maximum level occupied by water-soluble polymer solution within the sample carrier. In an alternative embodiment, both feeds can be located on the connecting means or on the sample carrier.

Preferably, the purging means is a safety valve, a non-return device or valve.

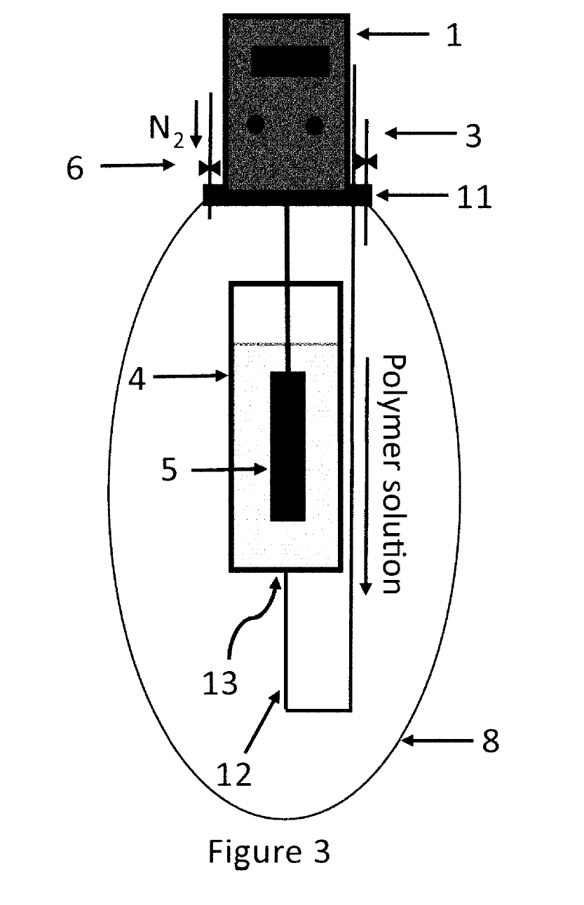

In a third embodiment (FIG. 3), the sample carrier (4) is totally inert. In practice, the sample carrier (4) is placed within a flexible chamber or inerting enclosure (8), which is at least partially transparent. The enclosure is rendered rigidly connected to the base of the head of the viscometer by means of a gas-tight junction (11) in the form of a ring attached to the periphery of the head. The ring (11) is provided with different recesses that allow for the passage of the inert gas supply (6), of the polymer solution supply (3) and that allow for the positioning of the purging means (3).

The opening of the inerting chamber is attached to the base of the head of the viscometer by means of the gas-tight junction (11) such that the volume within the enclosure and under the lower face of the viscometer head is a closed and gas sealed volume. This volume can be filled with inert gas through an opening (6) provided through the gas-tight junction (11) and can be purged thanks to the purging means (3), that is also provided in the gas-tight junction (11). The purging means (3) is preferably a valve.

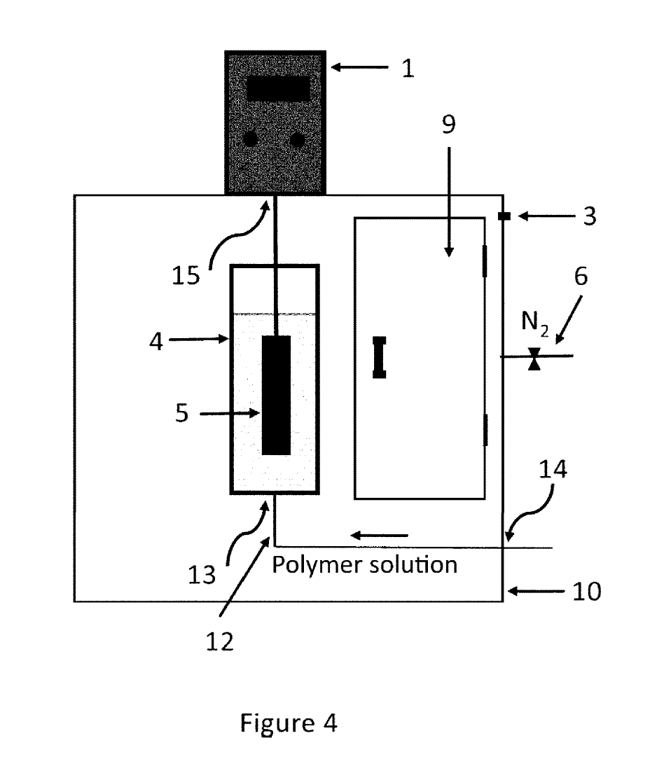

In a fourth embodiment (FIG. 4), the sample carrier (4) and the single module (5) of the viscometer are completely inerted by being placed within a flexible or rigid inerting chamber (10) comprising:
A means for introducing the hands of an operator into the enclosure outside periods of being inert in this case, an access door (9)
An opening (15) allowing the passage of the module such that the head of the viscometer 1 is located outside the inerting chamber;
An opening (6) serving to supply inert gas to the inerting chamber;
An inerting chamber purging means (3); preferably a safety valve or a non-return device.
An opening (14) to allow the sample carrier to be fed with the aqueous solution to be analyzed.

The inerting chamber or enclosure can be either rigid or flexible. Preferably, the inerting chamber is rigid.

The shape and dimensions of the inerting chamber are chosen such that the viscometer sample carrier can be introduced into the enclosure of the inerting chamber whilst keeping the head of the viscometer outside. Preferably, the inerting chamber has the shape of a parallelepiped whose length is between 30 and 60 cm, the width is between 30 and 60 cm and the height is between 30 and 50 cm.

The walls of the inerting chamber may be, partially or fully, transparent or opaque. Preferably, at least one of the faces of the inerting chamber will be at least partially transparent.

To install the viscometer sampling carrier and also to be able to clean it outside periods of being inert, the inerting chamber is provided with a door (9). No manual manipulation in an inert atmosphere within the inerting chamber is required. The presence of gloves attached to the walls of the inerting chamber is therefore unnecessary.

### Example 2: Viscosity Measurement

### Example A

The brine (composition: 4.5 g/L NaCl; (0.15 g/L CaCl₂, 2 H₂O) is made in glove box (model GP concept T4 Length 2.70 m/Height 1.85 m/Depth 1.30 m) with deoxidized deionized water. A stock solution of 5000 ppm of copolymer A: 70/30 mol % acrylamide/sodium acrylate (18 million Daltons) is prepared before being diluted to 1000 ppm with brine. The viscosity of the solution is measured.

### Example B

The viscosity of the solution of example A is measured in a glove box after the addition of 10 ppm of Iron II.

The prepared polymer solution of example B is divided into four fractions.

### Example C

a fraction of the solution prepared in example B is taken out of the glove box and exposed to the air. The residual viscosity is measured.

### Example D

The second fraction of the solution of example B is moved to a stainless steel cell whilst keeping the solution anaerobic. The stainless steel cell is pressurized to 3-5 bar with nitrogen. The stainless steel cell is similar to the material used for the practical sampling of the solution in the field. The cell is attached to an inert mounting corresponding to FIG. 4, the oxygen quantity is controlled by a PreSens sensor. The polymer solution is transferred to the viscometer measurement module and the viscosity is measured.

### Example E

Five percent of a radical capture stabilizer is added to the third fraction of the solution of example B, the viscosity is measured in a glove box.

### Example F

The fraction of example E is taken out of the glove box and is exposed to the air. The residual viscosity is measured.

### Example G

Five percent of the radical capture stabilizer is added to the fourth fraction of the solution of example B, the viscosity is measured. This fraction is transferred to a stainless steel cell whilst keeping the solution anaerobic. The stainless steel cell is pressurized to 3-5 bar with nitrogen. The stainless steel cell is similar to the material used for the practical sampling of the solution in the field. The cell is attached to an inert mounting corresponding to FIG. 4, the oxygen quantity is controlled by a PreSens sensor. The polymer solution is transferred to the viscometer measurement module and the viscosity is measured.

| Exam- | | Conditions of | Oxygen | Viscos- |
|---|---|---|---|---|
| ple | Composition | measurement | Content | ity (CP) |
| A | 1000 ppm Polymer A | Glove Box | 5 ppb | 30 |
| B | 1000 ppm Polymer A + | Glove Box | 5 ppb | 31 |
| | 10 ppm Fe II | | | |
| C | 1000 ppm Polymer A + | Outside the | Aerobic | 5 |
| | 10 ppm Fe II | glove box | condition | |
| D | 1000 ppm Polymer A + | Inert mounting | 3 ppb | 26 |
| | 10 ppm Fe II | of FIG. 4 | | |
| E | 1000 ppm Polymer A + | Glove Box | 5 ppb | 31 |
| | 10 ppm Fe II + | | | |
| | stabilizer | | | |
| F | 1000 ppm Polymer A + | Outside the | Aerobic | 22 |
| | 10 ppm Fe II + | glove box | condition | |
| | stabilizer | | | |
| G | 1000 ppm Polymer A + | Inert mounting | 4 ppb | 30 |
| | 10 ppm Fe II + | of FIG. 4 | | |
| | stabilizer | | | |

These examples show that the measurement device, in an inert atmosphere, of the invention, of a polymer sensitive to degradation in an aerobic environment (examples C and F) allows for reliable measurements with little degradation of the polymer (comparison examples D/A and G/E) and does so whether the polymer solution has or has not been previously stabilized before the viscosity measurement.

What is claimed is:

1. A device for measuring the viscosity of a solution whose viscosity is unstable under aerobic conditions, said device being adapted to be connected to a source containing the solution and comprising:
a Brookfield viscometer comprising a viscometer head wherefrom a module emerges, the viscometer head designating an assembly containing means for rotating the module and at least one display device together with a control mechanism for the device;
a container into which the module is immersed,
a purging means,
characterized in that said device further comprises means for placing an interior of the container in contact with an inert gas and in that the container has inlet means for the solution adapted to be connected to the source.

2. The device according to claim 1, characterized in that the inlet means for the solution is in the form of a tube opening into one of the walls of the container.

3. The device according to claim 1, characterized in that the means for placing the interior of the container in contact with an inert gas is in the form of a sealed closure means separating the viscometer head from the opening of the container in combination with a means for supplying inert gas to the volume, separating the viscometer head at a solution level.

4. The device according to claim 3, characterized in that the sealing means is in the form of an o-ring or sleeve.

5. The device according to claim 1, characterized in that the purging means is arranged in a side wall of the container.

6. The device according to claim 1, characterized in that the means for placing the interior of the container in contact with an inert gas is in the form of a sealed enclosure within which are located the constituent module of the viscometer and the container, and into which open:
a pipe supplied with inert gas,
the inlet means for the solution adapted to be connected to the source,
the purging means.

7. The device according to claim 6, characterized in that the enclosure has an access door for the hands of the operator.

8. A method of analysis, in an inert atmosphere, of the viscosity of a solution whose viscosity is unstable under aerobic conditions, characterized in that the method implements the device of claim 1 and comprises the following steps:
a) Rendering inert the inside of at least the container;
b) Injecting the solution to be analyzed into the container;
c) Measuring the viscosity of the solution to be analyzed.

9. The method of analysis according to claim 8, characterized in that an oxygen content of the inert atmosphere is measured using a probe between step a) and step b).

10. A use of the device of claim 1 for measuring the viscosity of an aqueous solution of water-soluble polymer, said solution originating from a main circuit of an oil recovery installation.

11. The use of the device according to claim 10, characterized in that the device is connected directly to the main circuit of the installation within which circulates the polymer solution the viscosity of which is to be measured.

12. The use of the device according to claim 10, characterized in that the device is connected to an outlet of a discharge pipe of a sampling tank of a polymer solution sampling device, the sampling device itself being connected to the main circuit of the installation, said sampling device comprising:
A first tank, referred to as the sampling tank, for containing the collected sample, comprising:
An inlet for the aqueous polymer solution to be sampled, and a sampling line connected to said input, said sampling line being provided with a no-shear sampling valve and being designed to be connected to the main circuit and
An outlet and an outlet pipe equipped with an outlet valve and connected to the output
A second tank, referred to as the treatment tank, for containing a stabilizing solution, having an output for the stabilizing solution, a connecting pipe connected to the outlet for the stabilizing solution and equipped with a treatment valve and allowing, at least in part, for a connection between the treatment tank and the sampling tank.

13. The use of the device according to claim 12, characterized in that the device is connected to the outlet of the sampling tank discharge pipe, previously detached from the sampling device.

14. The device according to claim 2, characterized in that the inlet means for the solution is in the form of a tube opening into one of the walls of the container at the bottom of the container.
